(19) United States
(12) Patent Application Publication
(10) Pub. No.: US 2014/0283730 A1
(43) Pub. Date: Sep. 25, 2014

(54) TOWER LIGHT AND A TIER THEREFOR

(71) Applicants: Raif Oymen, Silverwater (AU); Ari Da Silva, Silverwater (AU)

(72) Inventors: Raif Oymen, Silverwater (AU); Ari Da Silva, Silverwater (AU)

(21) Appl. No.: 14/342,527

(22) PCT Filed: Oct. 21, 2013
(86) PCT No.: PCT/AU2013/001215

§ 371 Date: Mar. 3, 2014

(30) Foreign Application Priority Data
Oct. 22, 2012 (AU) 2012904593

(51) Int. Cl. G08B 5/00

(52) U.S. Cl. CPC G08B 5/00
USPC 116/202

(57) ABSTRACT

A tier for a tower light consists of a tubular body having spaced apart inner and outer walls joined together to maintain a fixed relationship and defining an annular space for receiving a sleeve and having an access opening in the outer wall through which the sleeve may be inserted into and removed from the annular space, the inner and outer walls being joined together by an annular base upon which the sleeve is seated.

There is also disclosed a tower light having one or more such tiers.

### TECHNICAL FIELD

This invention relates to tower lights or candle lights which include a number of tiers of different colours and/or presenting different information.

For the sake of convenience, the invention will be described in relation to tower lights for use on the top of gaming machines where the lit colour of each tier indicates information such as the denomination of the machine, the jackpot status, attendance for payouts or faults.

### BACKGROUND ART

Such tower lights can be constructed with one, two, three or four light tiers. Hitherto, the colour of, or the information presented by, each tier was determined by the user before the tower light was assembled by placing coloured or printed sleeves within a tier or making a tier in a specific colour or printing information on it. Thus, when a different presentation of tiers was required, the tower light must be dismantled, the appropriate tiers replaced and the light re-assembled.

### DISCLOSURE OF INVENTION

According to one aspect of the invention there is provided a tier for a tower light comprising a tubular body having a side access opening through which a sleeve may be inserted into the interior of the tubular body.

According to another aspect of the invention there is provided a tier for a tower light comprising a tubular body having spaced apart inner and outer walls joined together to maintain a fixed relationship and defining an annular space for receiving a sleeve and having an access opening in the outer wall through which the sleeve may be inserted into and removed from the annular space.

In a preferred form of the invention, the inner and outer walls are joined together by an annular base upon which the sleeve is seated.

According to another aspect of the invention there is provided a tower light having one or more tiers as defined in the preceding two paragraphs.

### BRIEF DESCRIPTION OF THE DRAWINGS

FIG. 1 is an exploded view of a tower light according to one aspect of the invention,

FIG. 2 is a plan view of a tier of the tower light shown in FIG. 1,

FIG. 3 is a top view of the tier shown in FIG. 3,

FIG. 4 is a perspective view of the tier shown in FIGS. 2 and 3, and

FIG. 5 is a perspective view showing a sleeve being inserted into the tier.

### MODES FOR CARRYING OUT THE INVENTION

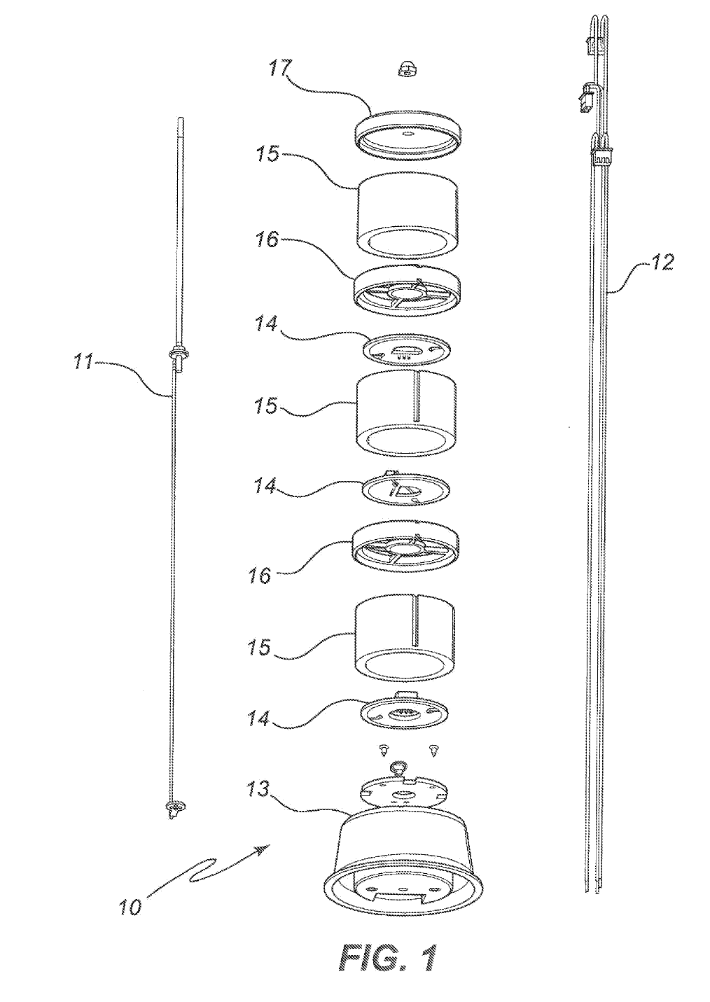

The tower light 10 shown in FIG. 1 includes an earth loom assembly 11, a light loom assembly 12 and a base 13. Above the base 1 is a tower blank 14, a tier 15 and a spacer 16. In this instance, there are three tiers 15 and associate componentry and a cap 17 at the top of the tower light 10.

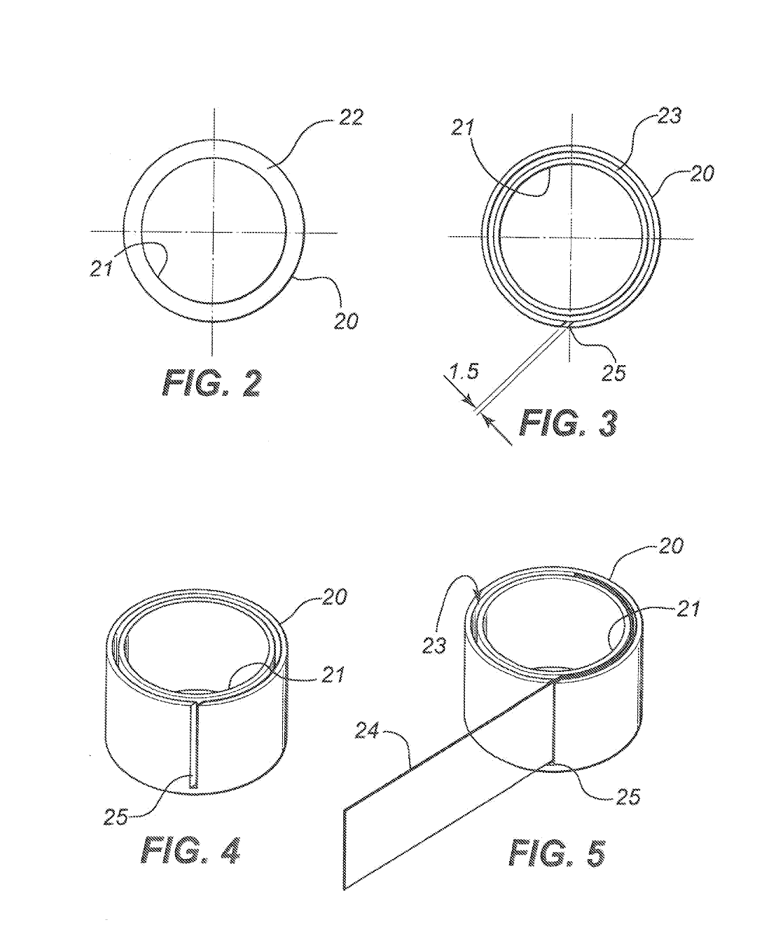

FIGS. 2, 3 and 4 show a tier 15 according to one embodiment of the invention. In this instance, the tier 15 consists of an outer cylindrical wall 20 and an inner cylindrical wall 21 which are upstanding from a base 22. The spaced apart walls 20 and 21 define a tubular body having an annular space 23 for receiving a sleeve 24.

As shown in FIGS. 3, 4 and 5, the outer wall 20 has an access opening formed as a slot 25 through which the sleeve 24 may be inserted into the annular space 23 and withdrawn therefrom as shown in FIG. 5.

Thus, the invention provides a colourless tube which can be used for each tier. The dimensions of the tube 15 can be varied to suit particular circumstances.

Although the invention has been described in relation to inner and outer tubular walls, it is to be understood that the inner wall 21 is a preferred feature of the invention as its role is merely for assistance in retaining the sleeve in position. Thus, in another form of the invention, the tier consists solely of the tubular wall 20 having the slot 25. In this instance, the sleeve is made from a material which does not curl when inserted.

As will be seen from FIGS. 3, 4 and 5, the slot 25 is at an angle to the tubular body so as to allow easy access of the sleeve 24 into the passageway 23. In this embodiment of the invention, the slot 25 is 1.5 mm wide.

Various modifications may be made in details of design and construction without departing from the scope and ambit of the invention.

### INDUSTRIAL APPLICABILITY

The invention has particular application in tower lights for use on the top of gaming machines.

1. A tier for a tower light comprising a tubular body having a side access opening through which a sleeve may be inserted into the interior of the tubular body.

2. A tier for a tower light comprising a tubular body having spaced apart inner and outer walls joined together to maintain a fixed relationship and defining an annular space for receiving a sleeve and having an access opening in the outer wall through which the sleeve may be inserted into and removed from the annular space.

3. A tier according to claim 2 wherein the inner and outer walls are joined together by an annular base upon which the sleeve is seated.

4. A tier according to claim 2 wherein the slot is at an angle to the tubular body.

5. A tower light comprising one or more tiers, the or each tier comprising a tubular body having spaced apart inner and outer walls joined together to maintain a fixed relationship and defining an annular space for receiving a sleeve and having an access opening in the outer wall through which the sleeve may be inserted into and removed from the annular space.

6. A tower tight according to claim 5 wherein the inner and outer walls of the each tier are joined together by an annular base upon which the sleeve is seated.

7. A tower light according to claim 5 wherein the slot is at an angle to the tubular body.
